(19) United States
(12) Patent Application Publication
(10) Pub. No.: US 2014/0269369 A1
(43) Pub. Date: Sep. 18, 2014

(54) METHOD, APPARATUS, AND COMPUTER PROGRAM PRODUCT FOR STATION CONTENTION

(71) Applicant: NOKIA CORPORATION, Espoo (FI)

(72) Inventor: Chittabrata Ghosh, Fremont, CA (US)

(21) Appl. No.: 13/843,188

(22) Filed: Mar. 15, 2013

(51) Int. Cl. H04W 24/08

(52) U.S. Cl. CPC H04W 24/08
USPC 370/252

(57) ABSTRACT

Method, apparatus, and computer program product embodiments of the invention are disclosed for station contention employable, for example, in connection with wireless networks. In an example embodiment of the invention, a method, comprises: employing a function, wherein said function takes as inputs at least one of: a station transmission opportunity duration, a station priority level, and a slot duration; and receiving, as output from said function, a station contention counter parameter.

### FIELD

The field of the invention relates to station contention employable, for example, in connection with wireless networks.

### BACKGROUND

Modern society has adopted, and is becoming reliant upon, wireless communication devices for various purposes, such as connecting users of the wireless communication devices with other users. Wireless communication devices can vary from battery powered handheld devices to stationary household and/or commercial devices utilizing an electrical network as a power source. Due to rapid development of the wireless communication devices, a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long-range communication networks, like GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth is an example of a short-range wireless technology quickly gaining acceptance in the marketplace. In addition to Bluetooth other popular short-range communication technologies include Bluetooth Low Energy, IEEE 802.11 wireless local area network (WLAN), Wireless USB (WUSB), Ultra Wide-band (UWB), ZigBee (IEEE 802.15.4, IEEE 802.15.4a), and ultra-high frequency radio frequency identification (UHF RFID) technologies. All of these wireless communication technologies have features and advantages that make them appropriate for various applications.

### SUMMARY

Method, apparatus, and computer program product embodiments of the invention are disclosed for station contention employable, for example, in connection with wireless networks.

In an example embodiment of the invention, a method, comprises:

employing a function, wherein said function takes as inputs at least one of:
a station transmission opportunity duration,
a station priority level, and
a slot duration; and

receiving, as output from said function, a station contention counter parameter.

In an example embodiment of the invention, the method further comprises wherein said station contention counter parameter is a contention window minimum.

In an example embodiment of the invention, the method further comprises wherein said station priority level is an access category.

In an example embodiment of the invention, the method further comprises performing contention based at least partly on said station contention counter parameter.

In an example embodiment of the invention, the method further comprises determining to dispatch, to a station, said station contention counter parameter.

In an example embodiment of the invention, the method further comprises wherein said employment is performed by one or more of a station and an access point.

In an example embodiment of the invention, the method further comprises wherein said slot duration is a duration of a slot within a restricted access window.

In an example embodiment of the invention, an apparatus comprises:

at least one processor; and

at least one memory including computer program code, the at least one memory and the computer program code configured to, with the at least one processor, cause the apparatus at least to perform:

employ a function, wherein said function takes as inputs at least one of:
a station transmission opportunity duration,
a station priority level, and
a slot duration; and

receive, as output from said function, a station contention counter parameter.

In an example embodiment of the invention, the apparatus further comprises wherein said station contention counter parameter is a contention window minimum.

In an example embodiment of the invention, the apparatus further comprises wherein said station priority level is an access category.

In an example embodiment of the invention, the apparatus further comprises wherein the at least one memory and the computer program code are further configured to, with the at least one processor, cause the apparatus to perform contention based at least partly on said station contention counter parameter.

In an example embodiment of the invention, the apparatus further comprises wherein the at least one memory and the computer program code are further configured to, with the at least one processor, cause the apparatus to determine to dispatch, to a station, said station contention counter parameter.

In an example embodiment of the invention, the apparatus further comprises wherein said employment is performed by one or more of a station and an access point.

In an example embodiment of the invention, the apparatus further comprises wherein said slot duration is a duration of a slot within a restricted access window.

In an example embodiment of the invention, a computer program product comprises computer executable program code recorded on a non-transitory computer readable storage medium, the computer executable program code comprising:

code for causing employ of a function, wherein said function takes as inputs at least one of:
a station transmission opportunity duration,
a station priority level, and
a slot duration; and

code for causing receipt, as output from said function, of a station contention counter parameter.

In an example embodiment of the invention, the computer program product further comprises wherein said station contention counter parameter is a contention window minimum.

In an example embodiment of the invention, the computer program product further comprises wherein said station priority level is an access category.

In an example embodiment of the invention, the computer program product further comprises wherein the computer executable program code further comprises code for causing performance of contention based at least partly on said station contention counter parameter.

In an example embodiment of the invention, the computer program product further comprises wherein said slot duration is a duration of a slot within a restricted access window.

In an example embodiment of the invention, an apparatus comprises:

means for employing a function, wherein said function takes as inputs at least one of:
a station transmission opportunity duration,
a station priority level, and
a slot duration; and

means for receiving, as output from said function, a station contention counter parameter.

In this manner, embodiments of the invention provide station contention functionality employable, for example, in connection with wireless networks.

### DESCRIPTION OF THE FIGURES

FIG. 1 discloses a first example contention procedure in accordance with at least one example embodiment of the present invention.

FIG. 2 discloses a second example contention procedure in accordance with at least one example embodiment of the present invention.

FIG. 3 discloses an example scenario wherein stations (STAs) are permitted to cross slot boundaries in accordance with at least one example embodiment of the present invention.

FIG. 4 discloses a deployment scenario in accordance with at least one example embodiment of the present invention.

FIG. 5 discloses a computer in accordance with at least one example embodiment of the present invention.

FIG. 6A discloses a functional block diagram in accordance with at least one example embodiment of the present invention.

FIG. 6B discloses a flow diagram in accordance with at least one example embodiment of the present invention.

FIG. 7 discloses a further computer in accordance with at least one example embodiment of the present invention.

### DISCUSSION OF EXAMPLE EMBODIMENTS OF THE INVENTION

### Station Contention—Contention Procedure Functionality

Station contention, contention procedure functionality according to at least one example embodiment will now be discussed. As discussed in greater detail herein, a station (STA) may perform contention under certain conditions. In so performing contention the STA, as a non-limiting example, may execute a back-off method (e.g., a carrier sense multiple access with collision avoidance (CSMA-CA) back-off method) in which the STA may initiate contention by, after the distributed inter-frame space (DIFS) period, activating a contention counter which has been set as will be discussed hereinbelow. Once the contention counter decrements to 0, the STA may gain medium access. Such functionality in one aspect may serve to avoid collisions between two STAs contending for the medium simultaneously. Where, for instance, network deployment supports quality of service (QoS), STA priorities, and/or access classes (ACs), in performing such contention the STA, as a non-limiting example, may act in a manner analogous to that discussed with respect to DIFS, but may employ an arbitration inter-frame space (AIFS) period in place of the noted DIFS period, the AIFS period employed possibly depending on STA priority. Such functionality may, for instance, be performed in connection with enhanced distributed channel access (EDCA).

Further according to the illustrative example, FIG. 1 shows a first example contention procedure according to at least one example embodiment. Access point (AP) 101 may establish restricted access window (RAW) 103 having slot 0 (105) and slot 1 (107). STA 1 (109), having a pending media access control protocol data unit (MPDU), may perform a first contention wherein the STA may activate a contention counter which may be set to “9” (111). In view of AP 101's dispatch of beacon 113, STA 1 (109) may freeze its contention timer at “2” (115). STA 1 (109), responsive to assigned slot 0 (105), may perform a contention wherein the STA activates a contention counter which may be set to “7” (117). The contention counter may decrement to zero, causing STA 1 (109) to gain medium access via transmission opportunity (TxOP) 119. STA 2 (121) may, responsive to beacon 113, exit doze state 123 and enter active state 125. STA 2 (121), responsive to assigned access slot 1 (107), may perform a contention wherein the STA activates a contention counter which may be set to “4” (127). The contention counter may decrement to zero, causing STA 2 (121) to gain medium access via TxOP 129.

Still further according to the illustrative example, FIG. 2 shows a second example contention procedure according to at least one example embodiment. AP 201 may establish RAW 203 having slot 0 (205) and slot 1 (207). STA 1 (209) may, responsive to AP 201's dispatch of beacon 211, exit doze state 215 and enter active state 217. STA 1 (209), responsive to assigned access slot 0 (205), may perform a contention wherein the STA activates a contention counter which may be set to “9.” In view of STA 2 (219) gaining medium access via TxOP 221 and transmitting on the medium, STA 1 (209) may freeze its countdown timer at “6” (223), and then restart its counter (225) in response to the ending of TxOP 221 and the medium becoming free. STA 1 (209), being subject to specification that slot boundary crossing is prohibited, may freeze its countdown timer (227) with the ending of its assigned slot. STA 2 (219) may, responsive to AP 201's dispatch of beacon 211, exit doze state 229 and enter active state 231. STA 2 (219), which may be also assigned to slot 0 (205), may perform a contention wherein the STA activates a contention counter which may be set to “4” and thusly to a value nearer to zero than the noted setting of STA 1's contention counter to “9.” The contention counter of STA 2 (219) may decrement to zero, causing STA 2 (219) to gain medium access via noted TxOP 221.

### Station Contention—Contention Counter Start Point Setting Functionality

Station contention, contention counter start point setting functionality according to at least one example embodiment will now be discussed. A STA may set and activate a contention counter, and gain medium access once the counter has decremented to zero. The contention counter may be set in view of a contention counter start point seed (e.g., contention window minimum (CW_min)). The start point of the contention counter may, as a non-limiting example, be set to a random number between zero and the seed. As another non-limiting example, the start point of the contention counter may be set to the seed. As discussed in greater detail herein, a STA and/or an AP may employ one or more factors in selecting such a contention counter start point seed. As a non-limiting example, such contention counter start point seed may be considered a station contention counter parameter.

As an illustrative example of such functionality, a factor in selecting a contention counter start point seed for a STA may be a TxOP duration of that STA. The TxOP duration may be the duration for which the STA is permitted to transmit on a medium subsequent to winning a contention for that medium, the EDCA TxOP duration of the STA, assigned to the STA by an AP, and/or received at the STA from an AP (e.g., via an EDCA information element (IE) within a beacon frame). This factor may be considered applicable both where STAs are permitted (e.g., in accordance with a cross slot boundary bit) to cross slot boundaries (e.g., such a STA is allowed medium access within one or more slots subsequent to an assigned slot), and where STAs are prohibited (e.g., in accordance with a cross slot boundary bit) from crossing slot boundaries (e.g., such a STA is disallowed medium access within one or more slots subsequent to an assigned slot). As non-limiting examples, cross slot boundary bits discussed herein may be indicated via RAW crossing boundary field and/or may be dispatched by APs to STAs via RAW parameter set (RPS) IE. As a further non-limiting example, in connection with that which is discussed herein a cross slot boundary bit value of 1 may indicate that slot boundary crossing is allowed whilst a cross slot boundary bit value of 0 may indicate that slot boundary crossing is prohibited. As an additional non-limiting example, in connection with that which is discussed herein a cross slot boundary bit value of 0 may indicate that slot boundary crossing is allowed whilst a cross slot boundary bit value of 1 may indicate that slot boundary crossing is prohibited.

Further according to the illustrative example, implementation may be such that an increase in TxOP duration causes a decrease in the contention counter start point seed (e.g., an decrease in CW_min) and/or such that a decrease in TxOP duration causes an increase in the contention counter start point seed (e.g., an increase in CW_min). The employment of TxOP as a factor in selecting a contention counter start point seed (e.g., as a factor in selecting CW_min) may be viewed as reducing the probability of collision among STAs contending for one or more commonly-assigned access slots (e.g., grouped STAs assigned to one or more same RAW slots for contention) in the case where those STAs have differing TxOP durations. By including TxOP duration as a factor in selecting contention counter start point seed, differences in TxOP duration amongst such contending STAs may result in differences in contention counter start point seeds (e.g., differences in CW_mins) amongst those STAs.

Still further according to the illustrative example, such employment of TxOP may also be seen as causing the seed (e.g., CW_min) to reflect priority. The TxOP duration assigned to a STA may be a function of the priority of that STA. As a non-limiting example, longer TxOP durations may be assigned to higher priority STAs and/or shorter TxOP durations may be assigned to lower priority STAs (e.g., longer duration TxOPs may be assigned to cellular offloading STAs and/or shorter duration TxOPs may be assigned to gas and/or other meter and/or sensor STAs). By reflecting TxOP differences the seed (e.g., CW_min) may reflect the priority differences behind those TxOP differences.

Also according to the illustrative example, a factor in selecting a contention counter start point seed (e.g., CW_min) for a STA may be a slot duration to which the STA is subject (e.g., the duration of slots of a RAW within which the STA is assigned one or more slots). This factor may be considered applicable both where STAs are permitted (e.g., in accordance with a cross slot boundary bit) to cross slot boundaries (e.g., such a STA is allowed medium access within one or more slots subsequent to an assigned slot), and where STAs are prohibited (e.g., in accordance with a cross slot boundary bit) from crossing slot boundaries (e.g., such a STA is disallowed medium access within one or more slots subsequent to an assigned slot).

Further according to the illustrative example, implementation may be such that an increase in slot duration causes an increase in the contention counter start point seed (e.g., an increase in CW_min) and/or such that a decrease in slot duration causes a decrease in the contention counter start point seed (e.g., a decrease in CW_min). Longer slot durations may be viewed as decreasing the granularity of medium availability to STAs and/or increasing the potential for collisions among contending STAs, and/or shorter slot durations may be viewed as increasing the granularity of medium availability to STAs and/or decreasing the potential for such collisions. The above-discussed linking of slot duration to contention counter start point seed (e.g., CW_min) may be seen as balancing out and/or mitigating such effects of slot duration magnitude.

Additionally according to the illustrative example, a factor in selecting a contention counter start point seed (e.g., CW_min) for a STA contending for a slot may be the slot number (e.g., RAW slot number) of that slot. This factor may be considered applicable where STAs are permitted (e.g., in accordance with a cross slot boundary bit) to cross slot boundaries (e.g., such a STA is allowed medium access within one or more slots subsequent to an assigned slot). Implementation may be such that an increase in slot number causes an increase in the contention counter start point seed (e.g., an increase in CW_min) and/or such that a decrease in slot number causes a decrease in the contention counter start point seed (e.g., a decrease in CW_min).

Further according to the illustrative example, where STAs are so permitted to cross slot boundaries slots with higher slot numbers may be viewed as potentially being contended for by a larger number of STAs due to STAs, which would have otherwise contended for lower-number slots, being forced to instead contend for higher-numbered slots due to those lower-numbered slots being occupied by STAs opting to cross into those lower-numbered slots. As a non-limiting example, FIG. 3 shows an example scenario wherein STAs are permitted to cross slot boundaries. A first STA may be the only STA to contend (301) in slot 1 (303). The first STA may then cross a slot boundary between slot 1 (303) and slot 2 (305) so as to transmit (307) in both slots. A second STA which would have otherwise contended in slot 2 (305) may contend (309) in slot 3 (311). Also contending (313) in slot 3 (311) may be a third STA. As such, higher-numbered slot 3 (311) may be subject to greater contention (two contending STAs) whilst lower-numbered slot 1 (303) may be subject to lesser contention (one contending STA).

Still further according to the illustrative example, a factor in selecting a contention counter start point seed (e.g., CW_min) for a STA assigned to contend for one or more access slots may be the total number of STAs assigned to contend for those slots (e.g., the total number of STAs in the STA's assigned RAW group). This factor may be considered applicable where STAs are prohibited (e.g., in accordance with a cross slot boundary bit) from crossing slot boundaries (e.g., such a STA is disallowed medium access within one or more slots subsequent to an assigned slot). Implementation may be such that an increase in such total number of assigned contending STAs causes an increase in the contention counter start point seed (e.g., an increase in CW_min) and/or such that a decrease in such total number of assigned contending STAs causes a decrease in the contention counter start point seed (e.g., a decrease in CW_min).

Also according to the illustrative example, larger quantities of STAs contending for one or more commonly-assigned slots may be viewed as increasing the potential for collisions among those STAs, and/or smaller quantities of STAs contending for one or more commonly-assigned slots may be viewed as decreasing the potential for such collisions. The above-discussed linking of total number of assigned contending STAs to contention counter start point seed (e.g., CW_min) may be seen as balancing out and/or mitigating such collision effects.

Additionally according to the illustrative example, a factor in selecting a contention counter start point seed (e.g., CW_min) for a STA—assigned to contend for one or more access slots with other STAs assigned to contend for those slots (e.g., a STA assigned to a RAW group)—for a particular time period for such contention (e.g., for a particular RAW period) may be the number of requests to send data during the particular time period (e.g., uplink data indicators (UDIs) corresponding to the particular time period) sent by the STA and/or by such other STAs during the preceding time period for such contention (e.g., the preceding RAW period). This factor may be considered applicable where STAs are prohibited (e.g., in accordance with a cross slot boundary bit) from crossing slot boundaries (e.g., such a STA is disallowed medium access within one or more slots subsequent to an assigned slot). Implementation may be such that an increase in such number of requests to send data causes an increase in the contention counter start point seed (e.g., an increase in CW_min) and/or such that a decrease in such number of requests to send data causes a decrease in the contention counter start point seed (e.g., a decrease in CW_min).

Further according to the illustrative example, larger numbers of such requests to send data may be viewed as increasing the potential for collisions, and/or smaller numbers of such requests to send data may be viewed as decreasing the potential for such collisions. The above-discussed linking of the quantity of such requests to send data to contention counter start point seed (e.g., CW_min) may be seen as balancing out and/or mitigating such collision effects.

Still further according to the illustrative example, a factor in selecting a contention counter start point seed (e.g., CW_min) for a STA may be the priority level (e.g., access category (AC)) of that STA. This factor may be considered applicable both where STAs are permitted (e.g., in accordance with a cross slot boundary bit) to cross slot boundaries (e.g., such a STA is allowed medium access within one or more slots subsequent to an assigned slot), and where STAs are prohibited (e.g., in accordance with a cross slot boundary bit) from crossing slot boundaries (e.g., such a STA is disallowed medium access within one or more slots subsequent to an assigned slot). Implementation may be such that a higher priority level (e.g., a higher AC) causes an decrease in the contention counter start point seed (e.g., an decrease in CW_min) and/or such that a lower priority level (e.g., a lower AC) causes an increase in the contention counter start point seed (e.g., an increase in CW_min). As a non-limiting example, such a STA being of a priority level (e.g., being of an AC) may be a QoS STA.

Also according to the illustrative example, providing a lower contention counter start point seed (e.g., a lower CW_min) to a STA may be viewed as affording that STA increased likelihood of achieving medium access (e.g., due to beginning its contention counter at a value closer to zero) at the expense of other STAs' decreased likelihood of achieving medium access, and/or providing a higher contention counter start point seed (e.g., a higher CW_min) to a STA may be viewed as affording that STA decreased likelihood of achieving medium access (e.g., due to beginning its contention counter at a value further from zero) to the benefit of other STAs who enjoy increased likelihood of achieving medium access. Allocation of such benefit and such expense may be from the point of view that STAs of higher priority level (e.g., higher AC) may be more deserving of such benefit, while STAs of lower priority level (e.g., lower AC) may be better able to weather such cost.

Additionally according to the illustrative example, for a STA assigned to contend for one or more access slots with other STAs assigned to contend for those slots, a factor in selecting a contention counter start point seed (e.g., CW_min) for that STA with respect to a particular contention of that STA may be whether such contention is to occur within or outside of those slots assigned for contention (e.g., within or outside of a corresponding RAW). Implementation may be such that a higher contention counter start point seed (e.g., a higher CW_min) is selected where the particular contention is to occur outside the one or more access slots to which the STA is assigned (e.g., outside of a corresponding RAW) and/or such that a lower contention counter start point seed (e.g., a lower CW_min) is selected where the particular contention is to occur within the one or more access slots to which the STA is assigned (e.g., within a corresponding RAW). As a non-limiting example, the STA may freeze counting of a contention counter at the beginning of access slots to which the STA is assigned (e.g., at the beginning of a corresponding RAW) and store the frozen contention counter value.

Further according to the illustrative example, it may be taken to be the case that larger quantities of STAs contend outside one or more slots assigned for contention (e.g., outside of a corresponding RAW) than within those slots (e.g., within a corresponding RAW). Such larger quantities of contending STAs may be viewed as increasing the potential for collisions, and/or smaller quantities of contending STAs may be viewed as decreasing the potential for collisions. The above-discussed linking of whether contention is inside or outside the one or more assigned access slots (e.g., whether contention is inside or outside of a corresponding RAW) may be seen as balancing out and/or mitigating such collision effects.

Still further according to the illustrative example, any one of the above-discussed contention counter start point seed selection factors may be used (e.g., via one or more functions and/or equations) in the selection of a contention counter start point seed (e.g., in the selection of a CW_min). Moreover, any two or more of the above-discussed contention counter start point seed selection factors may be taken together (e.g., via one or more functions and/or equations) in the selection of a contention counter start point seed (e.g., in the selection of a CW_min). Such selection of a contention counter start point seed (e.g., selection of CW_min) may be AP-performed and/or STA-performed. Example functions and equations employable in such seed selection are discussed herein. Where a STA or AP is to perform seed selection but lacks one or more data items to be used in that selection (e.g., the STA or AP lacks one or more data items called for by one or more corresponding functions and/or equations), the STA or AP may receive those one or more data items from an AP or STA that possesses them. As a non-limiting example, an AP which is to perform seed selection using one or more functions and/or equations which call for one or more data items possessed by one or more STAs but not possessed by the AP (e.g., one or more data items typically not known by APs but typically known by appropriate STAs), the AP may receive some or all of such data items from one or more STAs possessing them. Where an AP performs seed selection (e.g., CW_min selection) with respect to a STA, the AP may provide the selection result (e.g., CW_min) to that STA. As non-limiting examples, such provision may be via beacon (e.g., by way of RPS IE) and/or via synch frame (e.g., with provision being dynamically in synch frames at the beginning of each idle RAW slot).

Additionally according to the illustrative example, as a first non-limiting example, the factors employed in selecting a contention counter start point seed (e.g., CW_min) for a STA may be the TxOP duration of the STA and the priority level (e.g., AC) of that STA. A function taking such TxOP duration and such priority level (e.g., AC) as inputs and producing such contention counter start point seed (e.g., CW_min) as output may be employed. As a second non-limiting example, the factors employed in selecting a contention counter start point seed (e.g., CW_min) for a STA may be the TxOP duration of the STA, the priority level (e.g., AC) of that STA, and the slot duration to which the STA is subject. A function taking such TxOP duration, such priority level (e.g., AC), and such slot duration as inputs and producing such contention counter start point seed (e.g., CW_min) as output may be employed.

Also according to the illustrative example, as a third non-limiting example, the factors employed in selecting a contention counter start point seed (e.g., CW_min) for a STA may be the priority level (e.g., AC) of that STA and the slot duration to which the STA is subject. A function taking such priority level (e.g., AC) and such slot duration as inputs and producing such contention counter start point seed (e.g., CW_min) as output may be employed. As a fourth non-limiting example, the factors employed in selecting a contention counter start point seed (e.g., CW_min) for a STA may be the TxOP duration of the STA and the slot duration to which the STA is subject. An equation:

$$seed = \frac{slot\_duration}{TxOP\_duration} ,$$

were seed is such contention counter start point seed (e.g., CW_min), slot_duration is such slot duration, and TxOP_duration is such TxOP duration may be employed. Such factor employment and/or such equation may be considered applicable where STAs are prohibited (e.g., in accordance with a cross slot boundary bit) from crossing slot boundaries (e.g., such a STA is disallowed medium access within one or more slots subsequent to an assigned slot). Such equation may output a constant (e.g., with respect to a particular RAW period) in the case where the crossing of slot boundaries is prohibited. As a non-limiting example, the calculation of such equation may be STA-performed (e.g., performed by STAs to whom the output of the equation applies, for instance STAs of a relevant RAW group), and/or calculation may be performed outside of the control of a corresponding AP.

Additionally according to the illustrative example, as a fifth non-limiting example, the factors employed in selecting a contention counter start point seed (e.g., CW_min) for a STA may be the slot number (e.g., RAW slot number) of the slot within which the STA contends, the TxOP duration of the STA, and the slot duration to which the STA is subject. An equation:

$$seed = slot\_number \cdot \frac{slot\_duration}{TxOP\_duration} ,$$

were seed is such contention counter start point seed (e.g., CW_min), slot_number is such slot number, slot_duration is such slot duration, and TxOP_duration is such TxOP duration may be employed. Such factor employment and/or such equation may be considered applicable where STAs are permitted (e.g., in accordance with a cross slot boundary bit) to cross slot boundaries (e.g., such a STA is allowed medium access within one or more slots subsequent to an assigned slot). As non-limiting examples, such factor employment and/or such equation may be considered applicable to QoS STAs, non-QoS STAs, and/or both QoS STAs and non-QoS STAs. As another non-limiting example, the calculation of such equation may be STA-performed (e.g., performed by STAs to whom the output of the equation applies). As a further non-limiting example, a STA performing such calculation may be aware of its corresponding slot number (e.g., by virtue of being aware of its traffic information map (TIM) location), and/or may be able to perform such calculation when desirous of initiating connection.

Further according to the illustrative example, as a sixth non-limiting example, the factor employed in selecting a contention counter start point seed (e.g., CW_min) for a STA assigned to contend for one or more access slots may be the total number of STAs assigned to contend for those slots (e.g., the total number of STAs in the STA's assigned RAW group). A function taking such total number of STAs as input and producing such contention counter start point seed (e.g., CW_min) as output may be employed. Such factor employment and/or such function may be considered applicable where STAs are prohibited (e.g., in accordance with a cross slot boundary bit) from crossing slot boundaries (e.g., such a STA is disallowed medium access within one or more slots subsequent to an assigned slot). As non-limiting examples, such factor employment and/or such function may be considered applicable to QoS STAs, non-QoS STAs, and/or both QoS STAs and non-QoS STAs. Such function may output a constant (e.g., with respect to a particular RAW period) in the case where the crossing of slot boundaries is prohibited.

Still further according to the illustrative example, as a seventh non-limiting example, the factor employed in selecting a contention counter start point seed (e.g., CW_min) for a STA may be the above-discussed number of requests to send data (e.g., number of UDIs). A function taking such number of requests to send data (e.g., number of UDIs) as input and producing such contention counter start point seed (e.g., CW_min) as output may be employed. Such factor employment and/or such function may be considered applicable where STAs are prohibited (e.g., in accordance with a cross slot boundary bit) from crossing slot boundaries (e.g., such a STA is disallowed medium access within one or more slots subsequent to an assigned slot). As non-limiting examples, such factor employment and/or such function may be considered applicable to QoS STAs, non-QoS STAs, and/or both QoS STAs and non-QoS STAs.

Also according to the illustrative example, as an eighth non-limiting example, the factor employed in selecting a contention counter start point seed (e.g., CW_min) for a STA (e.g., within a RAW period) may be the priority level (e.g., AC) of that STA. A function taking such priority level (e.g., AC) as input and producing such contention counter start point seed (e.g., CW_min) as output may be employed. Such factor employment and/or such function may be considered applicable both where STAs are permitted (e.g., in accordance with a cross slot boundary bit) to cross slot boundaries (e.g., such a STA is allowed medium access within one or more slots subsequent to an assigned slot), and where STAs are prohibited (e.g., in accordance with a cross slot boundary bit) from crossing slot boundaries (e.g., such a STA is disallowed medium access within one or more slots subsequent to an assigned slot). As non-limiting examples, such factor employment and/or such function may be considered applicable to QoS STAs.

Additionally according to the illustrative example, FIG. 4 shows a deployment scenario according to at least one example embodiment. Shown in FIG. 4 are AP 401, and STAs 403 and 405. STAs 403 and 405 may receive from AP 401 communications (407, 409) of the sort discussed herein (e.g., beacons). STAs 403 and 405 may access (411, 413) the medium as discussed herein (e.g., subsequent to experiencing contention counter decrement to zero. The Institute of Electrical and Electronics Engineers 802.11ah task group is specifying a sensor network to which at least some embodiments discussed herein may be applied.

### Hardware and Software

The foregoing discusses computers, such as the discussed AP and STA devices, performing a number of operations. Examples of computers include smart cards, media devices, personal computers, engineering workstations, PCs, PDAs, portable computers, computerized watches, wired and wireless terminals, telephones, communication devices, nodes, servers, network access points, network multicast points, network devices, network stations, set-top boxes, personal video recorders (PVRs), game consoles, portable game devices, portable audio devices, portable media devices, portable video devices, televisions, digital cameras, digital camcorders, Global Positioning System (GPS) receivers, sensors, and wireless personal servers.

Running on such computers may be one or more operating systems. Examples of operating systems include Windows Phone (e.g., Windows Phone 8 or Windows Phone 7), Windows (e.g., Windows 8, Windows 7, or Windows Vista), Windows Server (e.g., Windows Server 2012, Windows server 2008, or Windows Server 2003), Maemo, Symbian OS, WebOS, Linux, OS X, and iOS. Supported by such computers may optionally be one or more of the S60 Platform, the .NET Framework, Java, and Cocoa.

Examples of computers also include one or more processors operatively connected to one or more memory or storage units, wherein the memory or storage optionally contains data, algorithms, and/or program code, and the processor or processors execute the program code and/or manipulate the program code, data, and/or algorithms.

FIG. 5 shows example computer 5000 including system bus 5050 which operatively connects two processors 5051 and 5052, random access memory 5053, read-only memory 5055, input output (I/O) interfaces 5057 and 5058, storage interface 5059, and display interface 5061. Storage interface 5059 in turn connects to mass storage 5063. Each of I/O interfaces 5057 and 5058 is an Ethernet, IEEE 1394, IEEE 1394b, IEEE 802.11a, 802.11af, 802.11 ah, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16m, IEEE 802.16x, IEEE 802.20, IEEE 802.22, IEEE 802.15.3, ZigBee (e.g., IEEE 802.15.4), Bluetooth (e.g., IEEE 802.15.1), Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Long Term Evolution (LTE), Global System for Mobile Communications (GSM), Code Division Multiple Access 2000 (CDMA2000), DVB-H (Digital Video Broadcasting: Handhelds), HDMI (High-Definition Multimedia Interface), Thunderbolt, or IrDA (Infrared Data Association) interface.

Further according to FIG. 5 mass storage 5063 may be a hard drive or flash memory. Each of processors 5051 and 5052 may be an ARM-based processor or an x86-based processor. Computer 5000 as shown in this example also includes a touch screen 5001 and physical keyboard 5002. Optionally a mouse or keypad may alternately or additionally be employed. Moreover, one or more of touch screen 5001 and physical keyboard 5002 may optionally be eliminated.

Additionally according to FIG. 5 computer 5000 optionally includes or is attached to one or more image capture devices. Examples of image capture devices include ones employing Complementary Metal Oxide Semiconductor (CMOS) hardware and ones employing Charge Coupled Device (CCD) hardware. One or more of the image capture devices may according to one example of an implementation be aimed towards the user. Alternately or additionally, one or more of the image capture devices may be aimed away from the user. The one or more image capture devices may be optionally employed by computer 5000 for video conferencing, still image capture, and/or video capture. Moreover, computer 5000 may optionally include or be attached to one or more card readers, DVD drives, floppy disk drives, hard drives, memory cards, or ROM devices whereby media containing program code—such as program code for performing the discussed operations—is optionally inserted for the purpose of loading the code onto the computer. Further, program code—such as program code for performing the discussed operations—may be optionally loaded the code onto the computer via one or more of I/O interfaces 5057 and 5058, perhaps using one or more networks.

According to an example of an implementation, executed by computers discussed herein may be one or more software modules designed to perform one or more of the discussed operations. Such modules are programmed using one or more languages. Examples of languages include C#, C, C++, Objective C, Java, Perl, and Python. Corresponding program code is optionally placed on media. Examples of media include DVD, CD-ROM, memory card, and floppy disk.

Any indicated division of operations among particular software modules is for purposes of illustration, and alternate divisions of operation are possible. Accordingly, any operations indicated to be performed by one software module may be according to an alternative implementation instead performed by a plurality of software modules. Similarly, any operations indicated to be performed by a plurality of modules may be according to an alternative implementation instead be performed by a single module.

Further, any operations indicated to be performed by a particular computer such as a particular device may be according to an alternative implementation instead performed by a plurality of computers such as by a plurality of devices. Moreover, peer-to-peer, cloud, and/or grid computing techniques may be optionally employed. Additionally, implementations may include remote communication among software modules. Examples of remote communication techniques include Simple Object Access Protocol (SOAP), Java Messaging Service (JMS), Remote Method Invocation (RMI), Remote Procedure Call (RPC), sockets, and pipes.

Optionally, operations discussed herein may be implemented via hardware. Examples of such implementation via hardware include the use of one or more of integrated circuits, specialized hardware, chips, chipsets, Application-Specific Integrated Circuits (ASICs), and Field-Programmable Gate Arrays (FPGAs). As a non-limiting example such hardware may be programmed to perform operations discussed herein using one or more languages such as one or more Hardware Description Languages (HDLs). Examples of HDLs include very-high-speed integrated circuit hardware description language (VDHL) and Verilog.

FIG. 6A is an example functional block diagram, illustrating an example AP or STA device 600 according to an example embodiment of the invention. The example device 600 includes a processor 634 that includes dual or multi-core central processing units CPU_{—}1 and CPU_{—}2, a RAM memory, a ROM memory, and an interface for a keypad, display, and other input/output devices. The example device 600 includes a protocol stack, including the transceiver 628 and IEEE 802.11ah MAC 642. The protocol stack includes a network layer 640, a transport layer 638, and an application program 636.

In an example embodiment, the interface circuits in FIG. 6A may interface with one or more radio transceivers, battery and other power sources, key pad, touch screen, display, microphone, speakers, ear pieces, camera or other imaging devices, etc. The RAM and ROM may optionally be removable memory devices 626 such as smart cards, subscriber identity modules (SIMs), wireless identification modules (WIMs), semiconductor memories such as RAM, ROM, PROMS, flash memory devices, etc. The processor protocol stack layers, and/or application program are according to an example of an implementation embodied as program logic stored in the RAM and/or ROM in the form of sequences of programmed instructions which, when executed in the CPU, carry out the functions of example embodiments. The program logic is according to an example of an implementation delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed ASICs. The one or more radios in the device may be separate transceiver circuits or alternately, the one or more radios may be a single RF module capable of handling one or multiple channels in a high speed, time and frequency multiplexed manner in response to the processor. Examples of removable storage media 626 include those based on magnetic, electronic, and/or optical technologies, such as magnetic disks, optical disks, semiconductor memory circuit devices, and micro-SD memory cards (SD refers to the Secure Digital standard) for storing data and/or computer program code as an example computer program product, in accordance with at least one embodiment of the present invention.

In an example embodiment of the invention, the device 600 of FIG. 6A is a device, comprising:

at least one processor 634;

at least one memory, RAM, ROM, and/or removable storage 626 including computer program code represented by the flow diagram of FIG. 6B;

the at least one memory and the computer program code configured to, with the at least one processor, cause the device 600 at least to:

employ a function, wherein said function takes as inputs at least one of:
a station transmission opportunity duration,
a station priority level, and
a slot duration; and

receive, as output from said function, a station contention counter parameter.

FIG. 6B discloses a flow diagram in accordance with at least one example embodiment of the present invention. 671 and 673 of FIG. 6B as a non-limiting example represent computer code instructions stored in the RAM and/or ROM memory of device 600, which when executed by the central processing units (CPU), carry out the functions of an example embodiment of the invention. 671 and 673 are performable in another order than shown and are combinable and/or separable into component operations. As such:

671: employing a function, wherein said function takes as inputs at least one of:
a station transmission opportunity duration,
a station priority level, and
a slot duration; and

673: receiving, as output from said function, a station contention counter parameter.

As noted, the foregoing discusses computers such as the discussed AP and STA devices. Shown in FIG. 7 is a block diagram of a further computer according to at least one example embodiment, terminal 7000. Terminal 7000 of FIG. 7 includes a processing unit CPU 703, a signal receiver 705, and a user interface (701, 702). Examples of signal receiver 705 include single-carrier and multi-carrier receivers. Signal receiver 705 and the user interface (701, 702) are coupled with the processing unit CPU 703. One or more direct memory access (DMA) channels may exist between multi-carrier signal terminal part 705 and memory 704. The user interface (701, 702) may include a display and a keyboard that enable a user to use the terminal 7000. In addition, the user interface (701, 702) may include a microphone and a speaker for receiving and producing audio signals. The user interface (701, 702) may optionally employ voice recognition.

The processing unit CPU 703 may be a microprocessor, may communicate with memory 704, and may optionally communicate with software. The software may be stored in the memory 704. The microprocessor may control, on the basis of the software, the operation of the terminal 7000, such as receiving of a data stream, tolerance of the impulse burst noise in data reception, displaying output in the user interface and the reading of inputs received from the user interface. The hardware may contain circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 7, middleware or software implementation may be optionally applied. Examples of terminal 7000 include a hand-held device such as a cellular mobile phone which includes the multi-carrier signal terminal part 705 for receiving multicast transmission streams. Therefore, the terminal 7000 optionally interacts with service providers.

It is noted that although APs and STAs have been discussed at various junctures in connection with IEEE 802.11 so as to facilitate ease of discussion, the APs and STAs discussed herein are not limited to IEEE 802.11 APs and STAs. Non-limiting examples of APs discussed herein include access points (IEEE 802.11 and/or other than IEEE 802.11), access nodes, base stations, and other devices. Non-limiting examples of STAs discussed herein include stations (IEEE 802.11 and/or other than IEEE 802.11), mobile terminals, and other devices. APs and STAs discussed herein are, as non-limiting examples, of the networking modalities discussed above in connection with input output (I/O) interfaces 5057 and 5058.

Example embodiments of the invention include an apparatus, comprising:

means for employing a function, wherein said function takes as inputs at least one of:
a station transmission opportunity duration,
a station priority level, and
a slot duration; and

means for receiving, as output from said function, a station contention counter parameter.

### Ramifications and Scope

Although the description above contains many specifics, these are merely provided to illustrate the invention and should not be construed as limitations of the invention's scope. For instance, various examples are articulated herein via the discussion of certain aspects. Such aspects are, themselves, merely examples and should not be construed as limitations of the invention's scope. Thus it will be apparent to those skilled in the art that various modifications and variations are applicable to the system and processes of the present invention without departing from the spirit or scope of the invention.

In addition, the embodiments, features, methods, systems, and details of the invention that are described above in the application are combinable separately or in any combination to create or describe new embodiments of the invention.

What is claimed is:

1. A method, comprising:
employing a function, wherein said function takes as inputs at least one of:
a station transmission opportunity duration,
a station priority level, and
a slot duration; and
receiving, as output from said function, a station contention counter parameter.

2. The method of claim 1, wherein said station contention counter parameter is a contention window minimum.

3. The method of claim 1, wherein said station priority level is an access category.

4. The method of claim 1, further comprising performing contention based at least partly on said station contention counter parameter.

5. The method of claim 1, further comprising determining to dispatch, to a station, said station contention counter parameter.

6. The method of claim 1, wherein said employment is performed by one or more of a station and an access point.

7. The method of claim 1, wherein said slot duration is a duration of a slot within a restricted access window.

8. An apparatus, comprising:
at least one processor; and
at least one memory including computer program code, the at least one memory and the computer program code configured to, with the at least one processor, cause the apparatus at least to perform:
employ a function, wherein said function takes as inputs at least one of:
a station transmission opportunity duration,
a station priority level, and
a slot duration; and
receive, as output from said function, a station contention counter parameter.

9. The apparatus of claim 8, wherein said station contention counter parameter is a contention window minimum.

10. The apparatus of claim 8, wherein said station priority level is an access category.

11. The apparatus of claim 8, wherein the at least one memory and the computer program code are further configured to, with the at least one processor, cause the apparatus to perform contention based at least partly on said station contention counter parameter.

12. The apparatus of claim 8, wherein the at least one memory and the computer program code are further configured to, with the at least one processor, cause the apparatus to determine to dispatch, to a station, said station contention counter parameter.

13. The apparatus of claim 8, wherein said employment is performed by one or more of a station and an access point.

14. The apparatus of claim 8, wherein said slot duration is a duration of a slot within a restricted access window.

15. A computer program product comprising computer executable program code recorded on a non-transitory computer readable storage medium, the computer executable program code comprising:
code for causing employ of a function, wherein said function takes as inputs at least one of:
a station transmission opportunity duration,
a station priority level, and
a slot duration; and
code for causing receipt, as output from said function, of a station contention counter parameter.

16. The computer program product of claim 15, wherein said station contention counter parameter is a contention window minimum.

17. The computer program product of claim 15, wherein said station priority level is an access category.

18. The computer program product of claim 15, wherein the computer executable program code further comprises code for causing performance of contention based at least partly on said station contention counter parameter.

19. The computer program product of claim 15, wherein said slot duration is a duration of a slot within a restricted access window.

20. An apparatus, comprising:
means for employing a function, wherein said function takes as inputs at least one of:
a station transmission opportunity duration,
a station priority level, and
a slot duration; and
means for receiving, as output from said function, a station contention counter parameter.
